(19) United States
(12) Patent Application Publication
(10) Pub. No.: US 2006/0133361 A1
(43) Pub. Date: Jun. 22, 2006

(54) External digital communication routing module

(76) Inventor: Winfred W. Wu, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/012,213

(22) Filed: Dec. 16, 2004

(51) Int. Cl. H04L 12/66

(52) U.S. Cl. 370/353

(57) ABSTRACT

An external digital communication routing module with a cordless host interface and at least a cordless handset is disclosed. The cordless host interface is used to connect a computer system. The computer system connects at least one communication network. The cordless host interface communicates with the communication network via the computer system. Besides, each cordless handset uses at least a wireless protocol to communicate with the cordless host interface, whereby the cordless handset can communicate with the communication network via the wire host interface.

### BACKGROUND OF THE INVENTION

1. Field of the Invention

The present invention generally relates to a cordless communication apparatus, and more particularly to cordless handset and a cordless host connecting to a computer system.

2. Description of the Prior Art

Telephone network mainly includes the public service telephone network (PSTN) and the public land mobile network (PLMN). The former and the latter connect to the end user by wired and cordless manner separately. The end users usually use fixed line phones at a fixed place to connect to PSTN. For convenience, cordless phones with a cordless handset and a cordless host replace the fixed line phones. The cordless host connects to PSTN by way of a fixed line and the cordless handset communicates with the PSTN by way of the cordless host. Therefore, the communication will resemble the mobile phones and not be limited in a fixed place.

Both of the cordless handset and cordless host can have the dialing functionality to select the target for communication. No matter a number is dialed by way of the cordless handset or the cordless host, the number is called out by the cordless host. That is, the cordless host replaces the fixed line phone and the cordless handset is the extension of the cordless host. The cordless handset just transmits the number to the cordless host when the cordless handset is dialed.

The communication between traditional cordless handset and cordless host is analog and easy to be interfered. Thus power must be raised to enhance the communication quality. Even within a shot distance between the cordless handset and the cordless host, noise still could happens if there is a strong interfering source nearby. Another kind of communication between cordless handset and cordless host is digital. Digital signals are encoded before it is sent and recovered by decoding after it is received, thus the interfered noise can be eliminated. With the ability for interference-proof, the power is not necessary to be raised for reducing noise and the signals are clear. However, the encoding and the decoding are necessary to be used for digital cordless (cordless) communication. Besides, specific protocol is also needed. Therefore digital cordless communication costs more.

Moreover, communication can also be performed by using VoIP (Voice over IP, Video over IP) via Internet protocol network (IP network). Comparing to telephone network, low cost is a advantage of VoIP via Internet protocol network. With extra communication routing apparatuses, i.e. instant messenger (IM) or Internet protocol phone (IP phone), VoIP via Internet protocol network can couple with the telephone network and the fees of long distance call can be reduced. In addition, more convenience for use could increase if cordless communication mentioned above can be applied.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

One objective of the present invention is to provide an external digital communication routing module to connect with the computer system as a multimedia extension of the computer.

Another objective of the present invention is to provide an external digital communication routing module to be a digital cordless phone for communicating with the telephone network.

Further object of the present invention is to provide an external digital communication routing module to be a digital cordless phone for communicating with the Internet protocol network.

Accordingly, the present invention provides an external communication routing module, comprising a cordless host interface and at least a cordless handset. The cordless host interface is used for externally connect to a computer system that connects to a public communication network and the Internet, wherein the cordless host interface communicates with the public communication network and the Internet via the computer system. Each cordless handset communicates with the cordless host interface by following at least a cordless communication protocol and communicates with the public communication network and the Internet via the cordless host interface.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates one embodiment of the present invention;

FIG. 2 is a diagram depicts a functional block diagram for one embodiment of the present invention; and

FIG. 3 is a diagram shows another functional block diagram for one embodiment of the present invention.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

Nowadays computers can connect to Internet and telephone network by using the network adapter and the modem (or modem adapter) separately. Thus the computers are suitable to be a communication router for communicating with the IP network and telephone network.

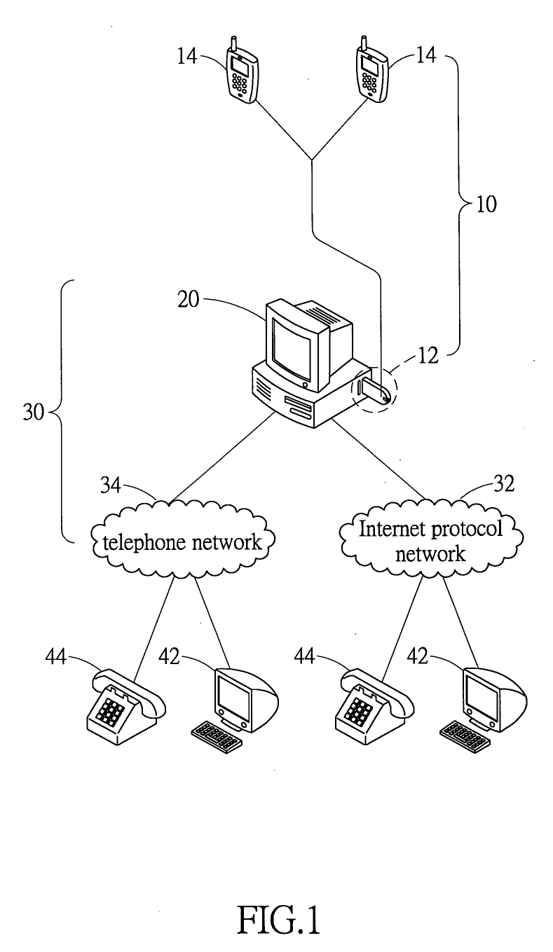

Accordingly, referring to FIG. 1, one embodiment of the present invention is an external digital communication routing module 10, comprising a cordless host interface 12 and at least a cordless handset 14. The cordless host interface 12 is used for connecting to a computer system 20 that is connected to at least public communication network 30, wherein the cordless host interface 12 communicates with the public communication network 30 by way of the computer system 20. The cordless host interface can be plugged into a bus of the computer system 20 or externally coupled with an USB port, a serial port, a parallel port, a 1394 port, or the like of the computer system 20. Moreover, each cordless handset 14 follows at least a cordless/wireless protocol to communicate with the cordless host interface 12. By way of the cordless host interface 12, each cordless handset 14 can communicate with the public communication network 30. Furthermore, the cordless/wireless protocol is a set selected from the following group: Bluetooth, IEEE 802.11 protocol, Digital Enhanced Cordless Telecommunications (DECT) protocol, and Infra red direct access (IRDA) protocol.

The public communication network can be an Internet protocol network 32 or a telephone network 34, whereby the computer system 20 can communicate with remote computers or phones via the Internet protocol network 32 or the telephone network 34. The foregoing telephone network can be a PSTN or PLMN. The contents of the communication may include a multimedia data, not limited to, comprising: audio, video, image, text or other electric records. Moreover, the cordless handset 14 can be cordless phone handset with the dialing functionality. By applying the dialing functionality, the cordless handset 14 can select the communication target (computers or phones) within the public communication network 30 by way of the cordless host interface 12. Similarly, the cordless host interface 12 can also be a cordless host with the dialing functionality. By applying the dialing functionality, the cordless host interface 12 can select the communication target (computers or phones) within the public communication network 30 by way of the computer system 20. Besides, the cordless handset 14 can communicate with another cordless handset 14 by way of the cordless host interface 12 to form an extra wireless communication network beyond the public communication network 30.

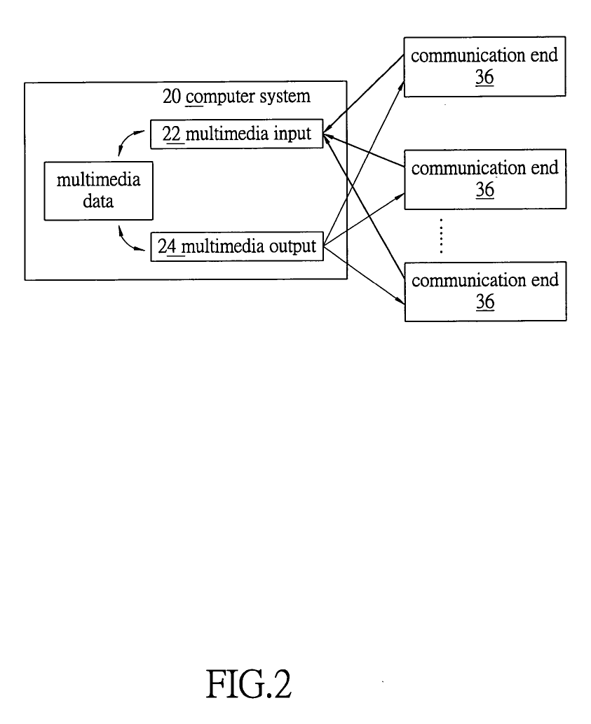

The multimedia data can be transmitted by two manners. FIG. 2 illustrates one of the two manners. The computer system 20 includes a multimedia input 22 and a multimedia out 24 that is used for communicating the multimedia data 50. The multimedia data 50 is imported from a communication end via the multimedia input 22 and exported to other communication ends via the multimedia out put 24 by the computer system 20. The communication ends may include the public communication network, cordless host interface, or the multimedia interface of the computer system.

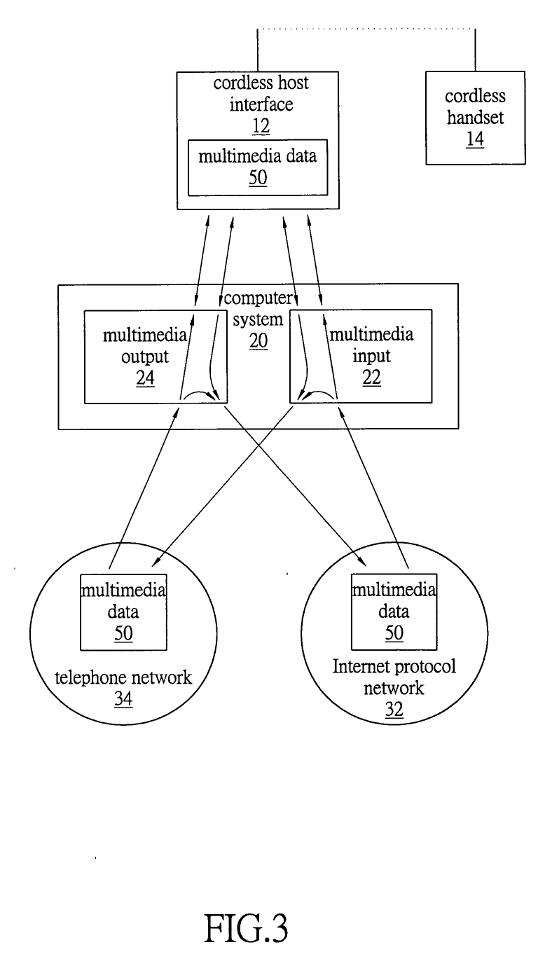

Furthermore, another manner for transmission is illustrated as FIG. 3. If the foregoing public communication network is an Internet protocol network 32, multimedia data is exported to the Internet protocol network 32 via the multimedia output 24 and imported from the Internet protocol network 32 via the multimedia input 24. Besides, the multimedia data from the Internet protocol network 32 is imported to the cordless handset 14 via the multimedia input 22 by way of the cordless host interface 12 and the multimedia data from the cordless handset 14 is exported to the Internet protocol network 32 via the multimedia output 24 by way of the cordless host interface 12. Oppositely if the public communication network is a telephone network 34, the multimedia data 50 is exported to the telephone network 34 via the multimedia input 22 and imported from the telephone network 34 via the multimedia output 24. The multimedia data from the telephone network 34 is imported to the cordless handset 14 via the multimedia output 24 by way of the cordless host interface 12 and the multimedia data from the cordless handset 14 is exported to the telephone network 34 via the multimedia output 22 by way of the cordless host interface 12. Therefore, the Internet protocol network 32 receives the multimedia data from the telephone network 34 via the multimedia output 24 and the telephone network 34 receives the multimedia data from the Internet protocol network 32 via the multimedia input 22. The roll reversal of the multimedia input 22 and the multimedia output 24 is controlled by the cordless host interface 12 to import or to export the multimedia data according to the target for transmission.

The multimedia data can be transmitted by following the VoIP when the computer system communicates with the Internet protocol network. For examples, the multimedia data can be transmitted by way of Instant Messenger by following the VoIP, thus the cordless handset can communicate with the Internet protocol network via the cordless host interface by using the Instant Messenger. Similarly, the instant messenger can communicate with the telephone network by way of the computer system, so can the cordless handset. Oppositely, the telephone network can communicate with the Internet protocol network via the computer system by using the Instant Messenger.

Moreover, the communication between communication ends does not limit to one-to-one communication, it can be a three-parties communication or multi-parties communication. That is, one communication end can transmit the multimedia data to a plurality of other communication ends.

Generally, the communication fees, particularly in long distance call, by using the Internet protocol network is cheaper than the communication fees by using the telephone network. Therefore two external digital communication routing modules separately connected to two computer systems can be applied for long distance call. Thus a user can use one cordless handset to communicate with another user with another cordless handset via Internet protocol network for saving communication fees. Furthermore, an external digital communication routing module can be used to transfer the multimedia data from the telephone network to the Internet protocol network, whereby another external digital communication routing module can transfer the received multimedia data from the Internet protocol network to the telephone network.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled. Moreover, the cordless handset can be a mobile phone or a communication apparatus that performs functionalities following the foregoing cordless communication protocol. The mobiles built in functionalities following blue tooth or IEEE 802.11 protocols can be used as a cordless handset.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. An external communication routing module, said external communication routing module comprises:
a cordless host interface, wherein said cordless host interface is used for externally connecting to a computer system coupling with a public communication network, wherein said cordless host interface communicates with said public communication network via said computer system;
at least a cordless handset, wherein said cordless handset communicates with said cordless host interface by following at least a cordless communication protocol and communicates with said public communication network via said cordless host interface.

2. A external communication routing module of claim 1, wherein said communication between said computer system and said public communication network includes the transmission of a multimedia data and said computer system includes a multimedia input and a multimedia output, wherein said multimedia data is transmitted via said multimedia input and said multimedia output.

3. A external communication routing module of claim 2, wherein said multimedia data is imported from a communication end via said multimedia input and exported via said multimedia output.

4. A external communication routing module of claim 3, wherein said communication end includes said public communication network and said cordless host interface.

5. A external communication routing module of claim 2, wherein said public communication network is an Internet Protocol (IP) Network.

6. A external communication routing module of claim 5, wherein said multimedia data is exported to said public communication network via said multimedia output and imported from said public communication network via said multimedia input.

7. A external communication routing module of claim 6, wherein said communication between said cordless handset and said cordless host interface includes the transmission of said multimedia data, wherein said multimedia data is imported from said Internet protocol network to said cordless handset via said multimedia input and exported from said cordless handset to said Internet protocol network via said multimedia output.

8. A external communication routing module of claim 2, wherein said public communication network is a telephone network.

9. A external communication routing module of claim 8, wherein said multimedia data is exported to said telephone network via said multimedia input and imported from said telephone network via said multimedia output.

10. A external communication routing module of claim 9, wherein said communication between said cordless handset and said cordless host interface includes the transmission of said multimedia data, wherein said multimedia data is exported from said telephone network via said multimedia output and imported to said telephone network via said multimedia input.

11. A external communication routing module of claim 8, wherein said telephone network is a public service telephone network (PSTN).

12. A external communication routing module of claim 8, wherein said telephone network is a public land mobile network (PLMN).

13. A external communication routing module of claim 1, wherein said wireless protocol is a set selected from the following group: Bluetooth, IEEE 802.11 protocol, Digital Enhanced Cordless Telecommunications (DECT) protocol, and Infra red direct access (IRDA) protocol.

14. A external communication routing module of claim 1, wherein said public communication network includes at least an Internet protocol network and said computer system uses at least one kind of instant messenger (IM) to communicate with said Internet protocol network, wherein said cordless handset communicates with said Internet protocol via said instant messenger used by said computer system.

15. A external communication routing module of claim 14, wherein said public communication network further includes at least a telephone network and said instant messenger communicates with said telephone network by way of said computer system, wherein said cordless handset communicates with said telephone network via said computer system.

16. A external communication routing module of claim 15, wherein said cordless handset communicates with said telephone network and said Internet protocol network to perform the multi-parties communication via said computer system.

17. A external communication routing module of claim 15, wherein said telephone network communicates with said Internet protocol network by way of said instant messenger used by said computer system.

18. A external communication routing module of claim 1, wherein the contents of said multimedia data are a set selected from the following group: audio, video, images, and text.

19. A external communication routing module of claim 1, wherein said cordless is a cordless telephone handset with the dialing functionality and said cordless telephone handset uses the dialing functionality to select a communication target within said public communication network via said cordless host interface.

20. A external communication routing module of claim 1, wherein said cordless host interface is a cordless telephone host with the dialing functionality and said cordless telephone host uses the dialing functionality to select a communication target within said public communication network by way of said computer system.

21. A external communication routing module of claim 1, wherein each of said cordless handsets communicates with other cordless handsets via said cordless host interface.

22. A external communication routing module of claim 1, wherein said cordless handset is a mobile phone performing functionalities following said cordless communication protocols.
